(19) United States
(12) Patent Application Publication
(10) Pub. No.: US 2017/0244437 A1
(43) Pub. Date: Aug. 24, 2017

(54) Social Network and Apps Card

(71) Applicant: Fabrizio Alieri, Milan (IT)

(72) Inventor: Fabrizio Alieri, Milan (IT)

(21) Appl. No.: 15/501,825

(22) PCT Filed: Aug. 4, 2015
(86) PCT No.: PCT/EP2015/025055

§ 371 Date: Feb. 4, 2017

Related U.S. Application Data
(60) Provisional application No. 62/032,706, filed on Aug. 4, 2014.

(51) Int. Cl. H04B 1/3816; G06K 19/04; G06K 19/07; H04W 4/20

(52) U.S. Cl. CPC H04B 1/3816; H04W 4/206; G06K 19/041; G06K 19/072

(57) ABSTRACT

This invention relates to a square with rounded angles smart card, in a non-conventional size, with a plurality of electronic circuits embedded in a specified pattern and assigned to different functionalities. This smart card with the means of a wired or contactless reader-writer apparatus, can be used for commercial, business or payment transactions and offers a number of advantages versus the old cards.

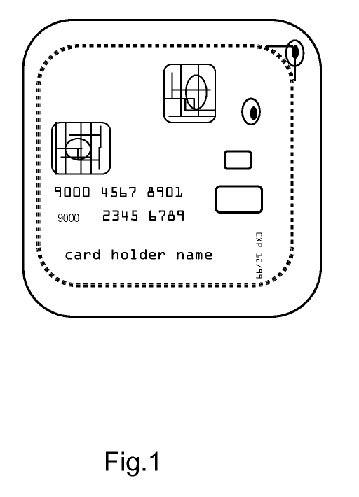

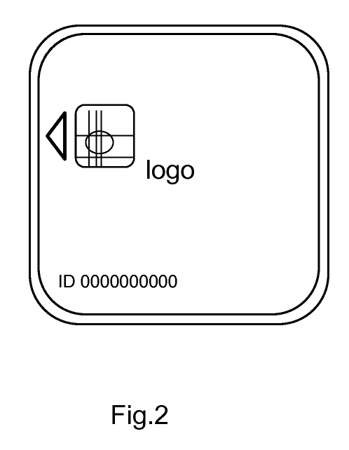

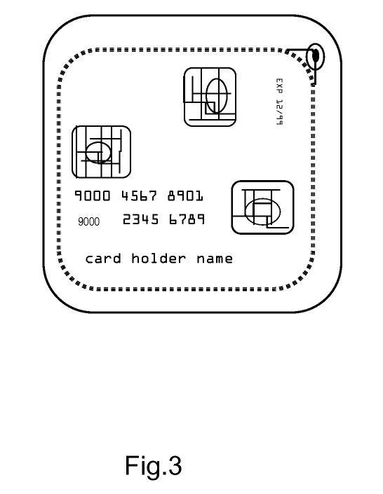

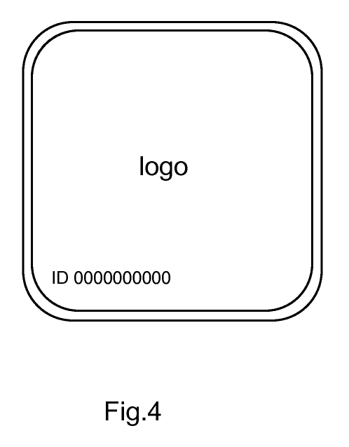

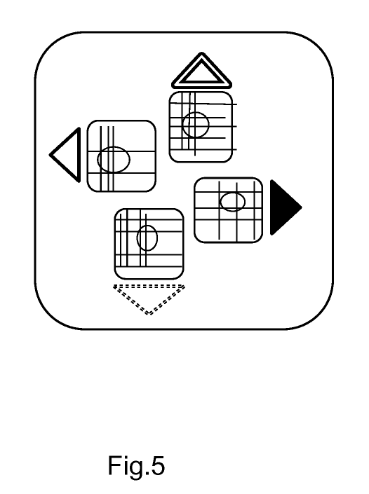

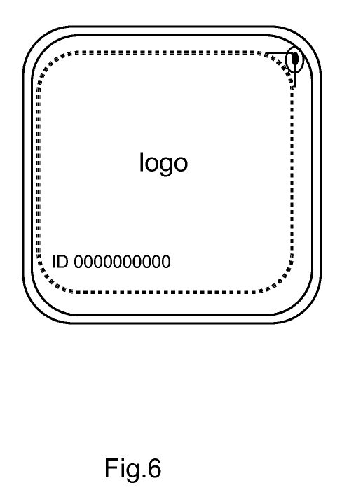

This invention relates to a novelty card, credit card, charge card, prepaid card or other electronic processing card or service card, or identification card or integrated circuit card, smart card or chip card or contactless card or alike that can perform most of the payment or identification or validating functions or data download and upload, through a variety of technologies and offers a number of advantages versus the old cards.

It is an object of the present invention to provide a novelty card that overcomes, or at least substantially reduces the disadvantages associated with the existing cards or instruments and it provides additional improvements versus the old cards.

The typical cards in use nowadays, for a variety of financial transactions or for identification purposes or for other card processing are manufactured with an excessive use of plastics or other materials, with respect to the quantity of material that effectively should serve for manufacturing a card of the same functionality. Most of the cards in use today measure 85.60 mm×53.98 mm (3×2 in) and conform to the ISO/IEC 7810 ID-1 Standard.

Yet, the generally adopted cards have a certain rotational stiffness and pliability that in some circumstances may result undesirable. The old known cards, or eventually cards of similar or same measures, due to their structures cannot perform specifically assigned multiple chip readings on multiple sides and faces and those cards have a minor redundancy that can compromise the functions of the card, due to a short circuit or a general failure of one chip.

The prior art does not show a card that has similar or extended functionalities with respect to a typical ISO/IEC 7810 ID-1 card, that clearly identifies or associate the holder as a member of a given social network or a fun of a specific mobile application, through the printing, in the typical aspect ratio, of the icon that resembles such network or mobile application, thus providing related specific services and validation tools.

It therefore becomes useful to provide the market with an invention that overcomes, or at least substantially reduces the disadvantages associated with the existing cards or instruments highlighted above and provide the markets with additional methods.

It is an object of the present invention to provide a novel and more flexible card, smartcard, integrated circuit or chip card that overcomes, or at least substantially reduces the described disadvantages associated with the existing cards or instruments.

This novelty card generally provides a reduction of plastic materials of about 35% or more, versus an ISO/IEC 7810 ID-1 standard sized card of the same thickness or material adopted and can encompass all or almost all of the available technologies, or simply the desired technologies, while providing additional advantages and improved functionalities. Although specific reader-writer apparatus might be preferred for this new card, a number of existing apparatus will be capable of performing the requested operations with minor modifications and therefore render the card adoptable by issuers, merchants and consumers.

This novelty card, offers also the advantage of hosting a number of chips or contact pads, up to four per face of the card, generally three in number that can be assigned to different banks, issuers or co-issuers, institutions or other service providers that can perform a number of validations, uploading or downloading of data, separately or jointly. Schematically, the problems and difficulties described in the prior art section are avoided by the present invention which provides a novelty card, credit card, charge card, prepaid card, service card, identification card, or other electronic processing card such as smart card or integrated circuit card or alike, that can perform some or all of the most common functions of this cards, or most of the payment or identification or validating functions through chip processing, contactless processing or eventually magnetic processing, or readable processing or a combination of the above processing methods for various purposes or service needs and being almost squared with rounded angles and having a typical but not limited size of about 2.123 inches per side or about 53.98 mm per side with a typical but not limited thickness of about 0.76 mm or 0.030 inches and a typical but not limited radius of about 3.18 mm or slightly different measures or proportions or aspect ratio, with a new structure and pattern of its components for performing specific chip readings in multichip environments, and that can be made of various plastic polymers and materials, layers or alloys, and have a full section of the same card, generally in one face of the card, where a button like image is displayed, and in such button like image a logo or an icon, generally of an affinity partner is inscribed thereto.

The manufacturing process for this card body can be generally done with plastic compounding and moulding techniques and the chips are embedded in a cavity. The appropriate manufacturing process is used for cards eventually made of other non plastic materials.

The adoption of this card results in a minor pliability and offers a major stiffness or resistance to bending, as a high-density polymer or an additional grid-pattern layer is eventually added between the layers of the card. The thickness of this novelty card, that generally remains the same as the traditional cards, may also be augmented by about 15% up to 100% for obtaining an additional rigidity or when it might be preferable, as more chips are positioned in the back face of the card. This card generally having the measures given above, it is manufactured with a new structure and the arrangement of the chips and other parts of the card having a new pattern, to perform specific desired operations in a multi-chips environment.

Accordingly the card can be inserted into the slot of a reading-writing apparatus through each of the four card edges with the face of the card up or down with respect to the same apparatus. In each face of the card, up to a maximum of four EMV or chips or contact pads can be applied.

EMV refers to a technical standard for smart cards, and their integrated circuits specifications, for chip based payment cards and acceptance devices. EMV is a Consortium currently own by major credit card Companies. The generally adopted EMV chips (of about 12.00 mm or 0.48 in per side) and EMV specifications of the integrated circuit chips, facilitate the global interoperability and acceptance of chip based cards, acceptance devices, including contactless payments and mobile devices. Chip is the short for microchip, an integrated circuit on one small plate (“chip”).

The mentioned chips, which are the nowadays chips used in a ISO/IEC 7810 ID-1 sized cards, from which the subsequent ISO/IEC 7816 has derived, are applied along the four sides of this new smart card of about 2.123 in or 53.98 mm per side, in the proximity of their edges. Eventually one or two sides of the card and a face of the card may have no chips applied.

Each chip embedded or punched in this new card is oriented and geometrically referenced with respect to the edge that enter in the slot of the reader, as the single chip of a standard 85.60 mm×53.98 mm (3.370 in×2.125 in) card is oriented and geometrically positioned with respect to the edge that goes into the reader and another adjacent edge of the same.

De facto as described in the previously filed U.S. Provisional Application for this non standard card:

The left border of the chip that goes into the reader, respect to the nearest parallel left side edge of the card, is at the approximate distance of 8.50 mm or 0.334 in and the horizontal top border of the chip is at the approximate distance of 18.10 mm or 0.712 in from the top horizontal side edge of the card.

This criterion and structure is generally adopted for all the other chips of this card, when standard EMV chips are adopted in this novelty card. When chips of different size or layout should be used, or the card varies in measures or aspect ratio, the positioning criterion changes accordingly, for performing the writing and/or reading operations with the dedicated reading apparatus, as the card is inserted into the slot of the apparatus through one of the 4 edges where chips are eventually positioned or with the face of the card upwards or downwards. Alternatively the contact pads and the reader-writer apparatus are specifically designed and calibrated for performing all the operations correctly. This electronic processing card with the new pattern described above, results effectively divided into multiple partitions thus improving the efficiency in a reduced amount of space.

In this card, each contact chip is generally allocated to perform pre-assigned functions and it delivers specific services to the user through one or more entities and systems that provide such functions and services, and each chip is positioned in the card for working properly or being read when the card is entered into the reader-writer apparatus through the side edge that is at the nearest proximity or closer side from that chip. The user therefore knows that when she or he desires to perform a specific action with the card (e.g. a withdrawal of funds or to redeem a voucher), she or he has to perform the operation through the side of the card where the chip is. Clearly the user receives the proper information related to the chips, as generally each chip has an arrow or other indicia that correspond to the functions assigned to that chip, therefore the user can recognize one specific chip and one side or face of the card as the one dedicated to the desired functions and perform the operations accordingly.

This card includes, in certain embodiments one or more RFID (the acronym for Radio Frequency Identification Device, the technology that through the wireless use of electromagnetic fields and permits the storage of information in the RFID module or tag) or UHF (Ultra High Frequency) or NFC modules (Near Field Communication Technology, a standards based wireless communication technology that allows data to be exchanged between devices that are few centimeters apart) with their relative contactless chip and their antenna applied in the lamination of the inlays, for performing contactless operations with enabled apparatus (i.e. smartphones). In some embodiments the antenna runs along the whole perimeter of the card at about 5 mm from the card edges, for providing better capacity and the chip module is generally further inside the card. In other embodiments the contactless chip and the antenna are positioned within a free space in the card. Additionally the card, in further embodiments, has an additional non-volatile memory card punched in its body. The wireless technologies above differs primarily from each other for the communication frequency used and their relative protocol standards, with RFID technology being able of a longer distance reading range capacity versus NFC that is capable of communicating wirelessly only when the NFC module or tag and the reader are at about 10 cm or 3.9 in from each other. The nowadays available NFC technology, also permits the enabled devices such as smart phones, to work in card emulation mode, in read-write mode or in peer to peer mode, for e.g. make secure payment transactions, read and write information or exchange and share data directly for example access files and share them directly.

This novelty card includes, depending on the embodiments or configuration, different types of data, logo and indicia. The numbering of this card consists in a range of numbers or set of numbers, generally of 12 to 19 digits in length, starting eventually with the known Issuer Identification Numbers (IIN) or with other numbers and preferably or ideally starting with the “9000” IIN ranges. The numbering is typically validated through the Luhn Algorithm eventually combined with other methods. The numbering for this card is applied preferably through printing and/or moderate engraving of the surface of the card, for leaving the reverse side or face of the card intact and flat. In certain embodiments, the traditional embossed numbering can also be adopted. This card includes, depending on the embodiments, the name of the cardholder or a code associated to the same, the expiration date, the issuer or issuers and co-issuers logo, holograms, a magnetic stripe which, if present, is preferably under a film layer, a signature field and a card security code. This novelty card eventually encompasses all this mentioned indicia, data and features, or only a part of them or a combination of the above mentioned ones.

Additionally the card has a printed ID numbering, and/or a non visual ID numbering, associated with the social network the owner of this card is a member of, or an ID associated to a mobile application, generally called “app”. Typically the just above mentioned ID is a numeric or alphanumeric 10 digit length code. The code can be associated and paired with one or more static or dynamic internet protocol address or addresses.

Beyond the type of indicia, technology and data mentioned above, this new card has also printed or displayed, in at least one face of the card, at its full size, or almost its full size, with respect to one face of the card, with minimum borders or extra borders left on the card, one almost squared with round angles button-shaped figure in which a logo is inscribed, and such image is typically acquainted as the icon that represents the mobile applications buttons, or a social networking logo, or the affinity partner logo, or other entity logo.

Yet, the holder of the card is generally a member of the network depicted in the card, also being a user of the related products and services provided directly or indirectly by the entity resembled or depicted in that logo, or in conjunction with the issuer and eventually multiple co-issuers of that card.

The aspect ratio of the icon-button printed or displayed in the card is generally corresponding to the aspect ratio of the card itself in the 1:1 ratio and such icon-button, generally overlays all the printable surface of the card, although a ratio of 4:3 may also be depicted in certain embodiments.

The card structure doesn't alter the graphic and visual aspect of the icons associated with the commonly used mobile apps and social networking icons and it is generally not necessary to modify the logos for covering the entire surface of the card, while the button shaped icon of a mobile app or of a determined social network is inscribed in a surface of a card with an extended multifunctional capacity with respect to the old cards.

A greater visibility is provided at the point of sale and during transactions or other operations where this card is handled in public places or private venues, providing additional advertising potentials, as it results more apparent to the people nearby that the holder is a member of a given network or the fan of a mobile app. Additionally when this card is placed in a badge-holder with the icon printed-side toward the viewer, it shows that the holder is the member of the network and such holder has the relative ID number for that network, without giving information regarding the card number that remains hidden in the other face of the card.

The card is pre-loaded with a number of mobile applications and redeemable vouchers or links that direct the user to a server. The connection is generally performed through NFC technology and the act of tapping, which is herein referred as to bring the two NFC enabled devices in a few centimeters proximity to each other for establishing a wireless connection in order to perform a variety of tasks including payments, data exchange, file transfer and file sharing, gaming, the launch of a mobile application and so on.

The act of tapping the button shaped image of the icon represented in the card (where underneath that image the NFC standard based connectivity technology reside) with proper apparatus (i.e. the enabled smartphone), provides a more human-centered interaction with the card. Therefore once the connection is established and the identification is successful, the applet corresponding to the icon in the card can be launched, or the access to the social network is confirmed to the user, providing additional security.

Generally a user, a third party or a guest is authorized to download an applet or a set of applets, links and vouchers of the owner of the card or share and add data. Typically the owner of the card receives a credit to his card. The owner of the card can create partitions within the card, upload the card with content and share vouchers and links of things and stuffs with other people, inviting them or accepting guests on demand, taking advantage of the button iconized logos positioned in the card (as it identifies the holder as a member of a certain network).

Preferably the face of the card where the applet logo resides has a clean graphics, uncompromised by visible technologies, with eventually the exception of one EMV or contact chip and eventually only the network ID numbering associated with the same.

The entity which is depicted through the social network logo/button, or the mobile app logo/button or other logo/button, typically acts also as the affinity partner of the card and its services and it shares on demand the data gathered through the actions and the preferences of the user, with other participants. The entity or affinity partner visualized in the card through the icon button has a dedicated contactless chip and/or contact chip or image recognition section in the card, that through the appropriate apparatus can be activated by a user or other party to perform operations of data reading-writing, uploading and downloading of data in conjunction or separately with a bank, issuer, merchant, payment processing operator, data service provider and/other users. Dedicated partitions of the technologies that reside in the card and their relative data can be either private or public and accordingly, an authorized guest-user can download or upload applications and various content through a Near Field Communication Technology enabled apparatus or other writing-reading apparatus and software.

The card is periodically uploaded and updated with content accessible by the user and its guest/s, when an action is performed with the card through a merchant or generally an ATM or a reader-writer apparatus. Generally the content remains in a dedicated partition of the card and it is accessible by the user on demand, tapping the card with a NFC enabled smartphone or other device that launches the proper software applications.

A Subscriber Identification Module (the integrated circuit card that is inside phones and securely store the international mobile subscriber identity number and related key which are used to identify and authenticate subscribers on the mobile telephony systems)—SIM, generally adopted by mobile operators it is also embedded or punched in some embodiments of the card. The SIM module of the card is intended to work independently or paired with a SIM module that is inserted in the smartphone or tablet or device of a given user, for identification, communications and validation purposes through the connection of other apparatus.

Generally when a SIM module of a mobile phone operator is in the embodiment of the card, the relative logo of the mobile phone operator is inscribed in the button shaped image in one side or entire face of the card and that mobile phone operator acts as the affinity partner.

The card is therefore pre-loaded with an app or it redirects a guest that taps or access the card to a server that, through the appropriate means, facilitate the migration from the mobile phone operator of the guest, which presumably is different from the one of the cardholder, to the mobile phone operator displayed in the card.

The information not collected automatically by the prospective mobile phone operator, are sent to the mobile phone operator represented in the card, after filling data in a window that appears in the mobile phone of the guest. Once all the necessary information are received by the prospective mobile phone operator, an offer with the best available subscription plan is sent to the guest and the migration procedure is initiated upon approval by the parties.

Eventually a specific embodiment of this card or a component of this card, non-owned by a cardholder, can also be positioned in a dedicated exhibitor or point of interaction in a public place.

Additionally if the phone of a determined user is lost, and such user still has its card, he can eventually notify the mobile operator of the loss of his phone, through an ATM or a point of sale, delete the data on the lost phone and request a new SIM and phone.

Yet, when this novelty card has its SIM module or chip paired with the mobile phone of the user or it is placed in a reader, wired or connected with the mobile phone of the user, it can activate validation procedures and specific operations to be performed by the same phone.

One or more chips can be dedicated, associated or paired with a national ID card, social security number, health records, insurance and driving license even through different partition of the same chip.

This card also provides a greater redundancy, as if one chip has a short circuit, malfunctions or has a whole failure, the other can equally perform all its functions. This can be performed with a chip on the same side or other side of the card and that chip being written by a writing/reading apparatus following the failure of the primary chip or because it was written already with a copy of the data in the primary chip. This card also provides generally a 2x up to a 4x greater storage capacity in a reduced amount of space versus other single-chip cards. Dedicated reader-writer apparatus for this card can perform the requested functions with brackets and contact pads that overlap the chips positioned in specific areas and faces of the card even simultaneously.

This card is delivered to new cardholders also through automatic vending machines that gather the necessary information from the social network such new cardholder is already a member of, or from her/his mobile phone operator subscription plan, or from mobile applications previously downloaded in a smartphone or other mobile apparatus or eventually by human actions at airports and insight airplanes, taking advantage of the identification in the boarding procedures.

Although the invention in the specification has been described in such terms that one skilled in the art can make and use the claimed invention, the understanding of the subject matter sought to be patented will be better understood in connection with some of the accompanying drawings.

What we claim is:

1. A square with rounded angles smart card for use with a reader-writer apparatus, said smart card comprises a plurality of chips embedded and arranged in a specified pattern that defines the position of each chip respect to the nearest vertical and parallel side edge of said smart card and assigns up to one chip and its relative functionality to one side of said smart card as to permit the insert and use of said smart card through the slot of the reader-writer apparatus through each side of the smart card where the chips are positioned.

2. The smart card of claim 1, wherein at least two chips are embedded in one face of said smart card in the proximity of two adjacent sides of the same and the opposite face of said smart card embeds a maximum of one chip which is not overlapped respect to anyone of the chips embedded in the opposite face of said smartcard.

3. The smartcard of one or more of claims 1-2 wherein the plurality of chips is embedded and arranged in a pattern that defines a constant value for the position of each chip respect to the nearest vertical side edge and parallel side edge of said smart card.

4. The smart card of claims 1 and 3 wherein the thickness of said smartcard is augmented twice its regular thickness with the insertion of an additional layer and said smart card comprises two chips embedded in the proximity of non adjacent sides of said smart card and further comprises two chips embedded in the opposite face of said smart card that are not overlapped with respect to the chips embedded in the opposite face.

5. The smart card of claims 1-2 and 4 wherein in the plurality of the chips embedded in said smart card, two of those adjacent chips are arranged in a pattern with a variable value that defines their relative position respect to their nearest vertical side edge and parallel side edge of said smart card.

6. The smart card of claims 1-2-3 and 5 wherein one face of said smartcard displays in full size with respect to the surface of said smart card a logo or an indicia or a logo inscribed into an icon button in the corresponding aspect ratio of said smartcard.

7. The smart card of any preceding claim, wherein said smart card comprises a RFID or NFC microchip with antenna and memory means to store, process data and communicate with an apparatus via radio waves

8. The smart card of one or more of claims 1-2-3-4-5 and 7 wherein one face of said smart card comprises an algorithm generated card-number which includes data related to the Issuer, data related to the Cardholder, the expiration date, an hologram and a verification code with a signature field for authentication and said smart card further comprises on the opposite face of same said smartcard a fully inscribed icon or logo of the affinity Partner of said smart card and an univocal ID serial number associated with a social network account paired with an univocal internet protocol address.

9. The smart card of one or more of the preceding claims wherein said smart card is writable and readable to process, execute or validate commercial, business or payment transactions by the means of a reader-writer apparatus that communicates and receives information through a global computer network and their interconnected computers and servers.

10. The smart card of claim 9 or any preceding claims wherein the reader-writer apparatus with which said smart card is connected for performing the requested tasks is an automatic teller machine, a point of sale terminal, an enabled smartphone, other mobile device with appropriate means, an automatic vending machine with reader-writer, or computer with reader-writer peripherals.

11. The smart card of one or more of the preceding claims wherein said smart card comprises one or more chips with memory means with private or public editable memory partitions where said smart card stores information related to the user, bank information, loyalty information and redeemable vouchers, information related to social networks, executable files, mobile applications and internet hyperlinks.

12. The smart card of claims 1-2-3-4-7-8 and 11 where a said smart card comprises a Subscriber Identification Module—SIM, punched in said smart card.

13. The smart card of one or more of the preceding claims, wherein said smart card is written and subsequently output from the slot of the reader-writer apparatus of an automatic teller machine or automatic vending machine with data gathered from servers connected with a social network through a global communications network

14. The reader-writer apparatus of said smart card whereas once the smart card of claim 12 is read, said reader-apparatus communicates through a global computer network with the servers of a mobile phone operator and transmits data related to said apparatus and smart card of claim 12 and receives data related to a subscription plan.

15. The smart card of any preceding claims, wherein the reader-writer apparatus of claims 9-10-13 performs the requested reading-writing tasks with a single contact pad that overlaps one chip of said smart card per time or alternatively through brackets and contact pads that overlaps more than on chip of said card simultaneously.
